(19) United States
(12) Patent Application Publication
(10) Pub. No.: US 2019/0055975 A1
(43) Pub. Date: Feb. 21, 2019

(54) Drywall Anchor Device

(71) Applicant: Marko Simic, Hernando, FL (US)

(72) Inventor: Marko Simic, Hernando, FL (US)

(21) Appl. No.: 15/605,763

(22) Filed: May 25, 2017

(51) Int. Cl. F16B 15/00; F16M 13/02

(52) U.S. Cl. CPC F16B 15/0023; F16B 2015/0076; F16M 13/02

(57) ABSTRACT

The drywall anchor device successfully anchors a plurality of objects to a drywall, thereby avoiding damage to the drywall and preventing the loss of anchor-to-drywall that is well known in the practice. The device is provided in a plurality of sizes to further prevent object-to-drywall separation, especially when attempting to anchor large objects and shower rods to the drywall. Anchored tines on the drywall anchor device greatly decrease workloads and problems known in such attempts, as the device is quickly tapped into place with a mallet, hammer, or the like.

### BACKGROUND OF THE INVENTION

Anchoring a plurality of items to drywall is often quite difficult, particularly since the items either dislodge from any anchoring means or from the drywall itself. Moreover, studs located behind the drywall are often not available in a chosen anchoring area to assist in better securing the screws. As a result, what has been needed is the present drywall anchor device that is structured to successfully anchor a plurality of objects to a drywall, while also avoiding any damage to the drywall. The drywall anchor device is provided in a plurality of sizes to further prevent object-to-drywall separation, which is especially common when a user attempts to anchor large objects such as shower rods to the drywall.

### FIELD OF THE INVENTION

The drywall anchor device relates to items that aid in fastening an object to a drywall, while concurrently avoiding displacement of the device and the object.

### SUMMARY OF THE INVENTION

The general purpose of the drywall anchor device, described subsequently in greater detail, is to provide a drywall anchor device that has many novel features that result in an improved drywall anchor device that is not anticipated, rendered obvious, suggested, or even implied by prior art, either alone or in combination thereof.

To attain this, the drywall anchor device includes a plate having a first side spaced apart from a second side. Each of the first side and the second side are optionally flat or substantially flat. The first side and the second side are also optionally parallel. Each plate has a perimeter that separates the first side from the second side.

Each of a plurality of spaced apart triangulated tines is extended perpendicularly outward from the second side. Moreover, a flat border of each of the plurality of triangulated tines is embedded through the second side. This structural feature specifically helps to prevent tine extraction from the plate. A point of each of the plurality of triangulated tines is disposed distally from the second side. The plurality of triangulated tines optionally equals at least four. At least a first pair of the plurality of triangulated tines is disposed diagonally apart and horizontally. At least a second pair of the plurality of triangulated tines is disposed diagonally apart and vertically. The plurality of triangulated tines at least includes a first tine, a second tine, a third tine, and a fourth tine. Each of the plurality of triangulated tines has at least a flat border opposing a point. The point pierces and partially continues inwardly within the drywall; however, at no time does the pierced drywall enlarge due to an excessive amount of each of the plurality of tines passing into the drywall. Each of the plurality of tines thereby enjoys greater gripping power within the drywall.

Each of the plates, with no plate relegated to having one of a rectangular and circular shape, further includes a plurality of hooks for optionally attachment within the plate and to aid in holding a plurality of items that a user may choose to hold.

Importantly, each of the plurality of tines can be one of smooth tines and toothed tines, which help to avoid slippage within or from the drywall. Another important structural feature of the device is that the plurality of tines is not limited to four.

Thus has been broadly outlined the more important features of the improved drywall anchor device so that the detailed description thereof that follows may be better understood and in order that the present contribution to the art may be better appreciated. The above structural features, together with additional objects, features and advantages of the improved drywall anchor device, will be readily apparent to those of ordinary skill in the art upon reading the following detailed description of presently preferred, but nonetheless illustrative, embodiments of the improved drywall anchor device when taken in conjunction with the accompanying drawings.

### BRIEF DESCRIPTION OF THE DRAWINGS

FIG. 1 is a perspective view of a rectangular plate drywall anchor device.

FIG. 2 is a perspective view of a circular plate drywall anchor device.

FIG. 3 is a second side plan view of the rectangular plate drywall anchor device.

FIG. 4 is a cross sectional view of a drywall anchor device.

FIG. 5 is a perspective first side view of the rectangular drywall anchor device.

FIG. 6 is a perspective view of the circular plate drywall anchor device in preparation of use.

### DETAILED DESCRIPTION OF THE DRAWINGS

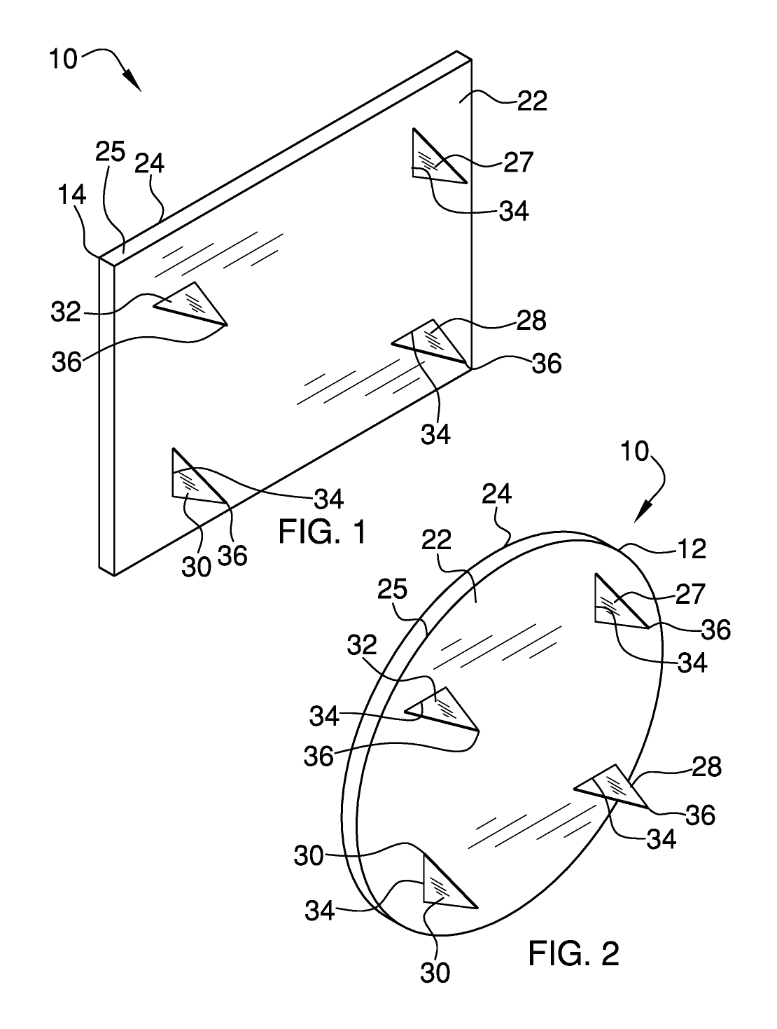

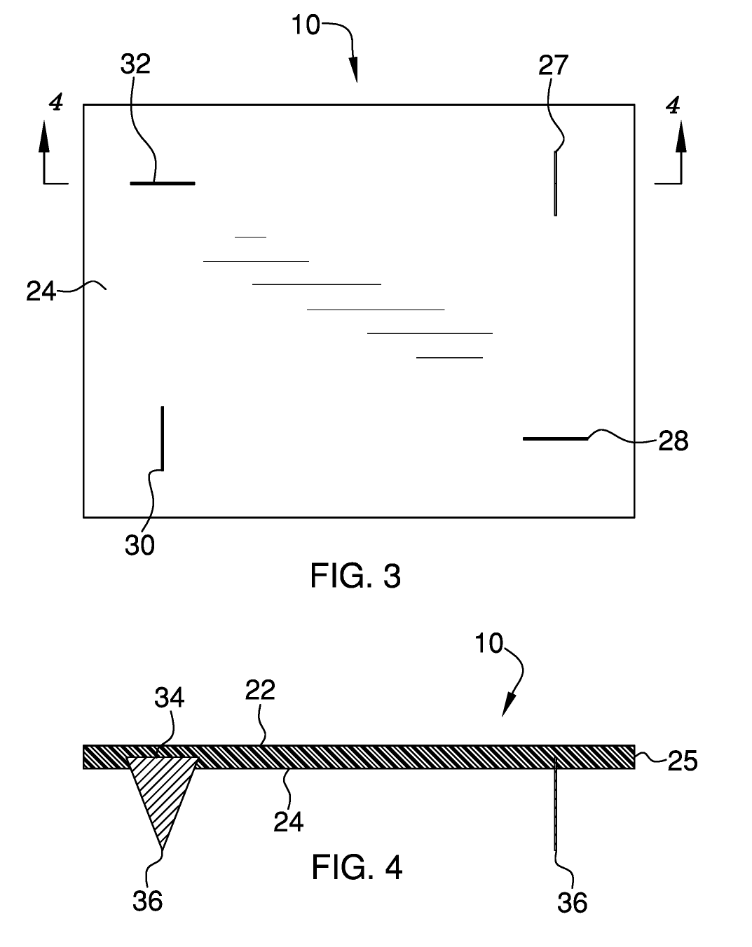

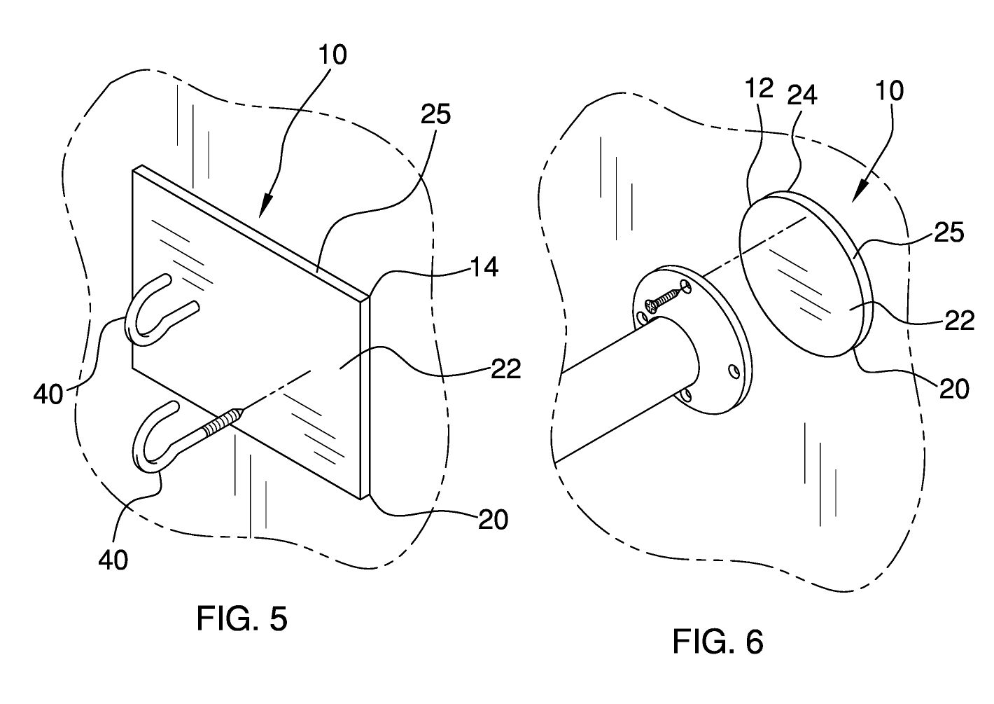

With reference now to the drawings, and in particular FIGS. 1 through 6 thereof, the principles and concepts of the drywall anchor device generally designated by the reference number 10 will be described.

The drywall anchor device 10 includes a plate 20 having a first side 22 spaced apart from a second side 24. Each of the first side 22 and the second side 24 is optionally flat or substantially flat. The first side 22 and the second side 24 are also optionally parallel. Each plate 20 has a perimeter 25 that separates the first side 22 from the second side 24. Each plate 20 is provided in at least circular 12 and rectangular 14 shapes.

Each of a plurality of spaced apart triangulated tines 26 is extended perpendicularly outward from the second side 24. A flat border 34 of each of the plurality of triangulated tines 26 is embedded through the second side 24. A point 36 of each of the plurality of triangulated tines 26 is disposed distally from the second side 24. The plurality of triangulated tines 26 optionally equals four. At least a first pair of the plurality of triangulated tines 26 is disposed diagonally apart and horizontally. At least a second pair of the plurality of triangulated tines 26 is disposed diagonally apart and vertically. The plurality of triangulated tines 26 at least includes a first tine 27, a second tine 28, a third tine 30, and a fourth tine 32. Each of the plurality of triangulated tines has at least a flat border 34 opposing a point 36. The point 36 pierces and partially continues inwardly within the drywall. Lastly, each of the plates 20 optionally includes a plurality of hooks 40.

Directional terms such as “front”, “back”, “in”, “out”, “downward”, “upper”, “lower”, and the like may have been used in the description. These terms are applicable to the embodiments shown and described in conjunction with the drawings. These terms are merely used for the purpose of description in connection with the drawings and do not necessarily apply to the position in which the drywall anchor device may be used.

The inventor claims:

1. A drywall anchor device comprising:
a plate having a first side spaced apart from a second side; and a plurality of spaced apart triangulated tines extended perpendicularly outward from the second side, wherein a flat border of each of the plurality of triangulated tines is embedded through the second side and a point of each of the plurality of triangulated tines is disposed distally from the second side;
wherein the plate is positioned between a drywall surface and a shower rod so as to provide enhanced security of said shower rod.

2. The drywall anchor device of claim 1 wherein the plurality of triangulated tines equals four, a first pair of the plurality of triangulated tines is disposed diagonally apart and horizontally, and a second pair of the plurality of triangulated tines is disposed diagonally apart and vertically.

3. The drywall anchor device of claim 1 wherein at least the second side is flat.

4. The drywall anchor device of claim 2 wherein at least the second side is flat.

5. The drywall anchor device of claim 1 wherein the plate is circular.

6. The drywall anchor device of claim 2 wherein the plate is circular.

7. The drywall anchor device of claim 3 wherein the plate is circular.

8. The drywall anchor device of claim 4 wherein the plate is circular.

9. The drywall anchor device of claim 1 wherein the plate is rectangular.

10. The drywall anchor device of claim 2 wherein the plate is rectangular.

11. The drywall anchor device of claim 3 wherein the plate is rectangular.

12. The drywall anchor device of claim 4 wherein the plate is rectangular.

13. A drywall anchor device comprising:
a rectangular plate having a flat first side spaced apart from a parallel flat second side;
and a plurality of spaced apart triangulated tines extended perpendicularly outward from the second side, wherein a flat border of each of the plurality of triangulated tines is embedded and bonded through the second side, a point of each of the plurality of triangulated tines is disposed distally from the second side, at least a first pair of the plurality of triangulated tines is disposed diagonally apart and horizontally, and at least a second pair of the plurality of triangulated tines is disposed diagonally apart and vertically, wherein each of the plurality of triangulated tines is disposed proximal a perimeter of the sides;
wherein the rectangular plate is positioned between a drywall surface and a shower rod so as to provide enhanced security of said shower rod.

14. The drywall anchor device of claim 13 comprising at least a pair of screw-in hooks selectively disposed through the first side.

15. A drywall anchor device comprising:
a circular plate having a flat first side spaced apart from a parallel flat second side; and a plurality of spaced apart triangulated tines extended perpendicularly outward from the second side, a flat border of each of the plurality of triangulated tines embedded and bonded through the second side, a point of each of the plurality of triangulated tines disposed distally from the second side, at least a first pair of the plurality of triangulated tines disposed diagonally apart and horizontally, at least a second pair of the plurality of triangulated tines disposed diagonally apart and vertically, wherein each of the plurality of triangulated tines is disposed proximal a perimeter of the sides;
wherein the circular plate is positioned between a drywall surface and a shower rod so as to provide enhanced security of said shower rod.

16. The drywall anchor device of claim 13 comprising at least a pair of screw-in hooks selectively disposed through the first side.
